(19) United States
(12) Patent Application Publication
(10) Pub. No.: US 2011/0074146 A1
(43) Pub. Date: Mar. 31, 2011

(54) STATIONARY RADIAL COMPRESSED AIR SUPPLY

(75) Inventors: Piotr Gorczak, Neuwied (DE); Antonius Kloft, Hahn Am See (DE)

(73) Assignee: WINKLER + DUENNEBIER AG, Neuwied (DE)

(21) Appl. No.: 12/994,521

(22) PCT Filed: May 19, 2009
(86) PCT No.: PCT/EP09/03570

§ 371 Date: Nov. 24, 2010

(30) Foreign Application Priority Data
May 27, 2008 (DE) 10 2008 025 222.0

(51) Int. Cl. F16L 17/035

(52) U.S. Cl. 285/110

(57) ABSTRACT

A roller air supply structure has a stationary compressed air supply having a stationary pressure chamber that can be loaded with pressure, and a rotatable roller that has at least one opening in a surface thereof operable to be loaded with compressed air from the stationary compressed air supply. The roller is surrounded in the axial area of the opening to be loaded with compressed air in the circumferential direction at least in sections by the stationary pressure chamber. The compressed air supply has a sealing element that can be moved by loading the pressure chamber with compressed air from a position of rest into a sealing position and by relieving the pressure of the pressure chamber to ambient pressure from the sealing position into the position of rest. The sealing element and the pressure chamber are constructed such that when the sealing element is in the position of rest there is no connection between the roller and walls of the pressure chamber, and when the sealing element is in the sealing position there is a pressure-tight connection between the walls of the pressure chamber and the roller.

### FIELD OF THE INVENTION

The invention concerns in general a stationary compressed air supply to a rotatable roller and in particular a radial compressed air supply to a pressure roller/pressure cylinder to be coated with a plastic casing.

### BACKGROUND

In a rotatable pressure machine pressure cylinders are currently used that are coated with a plastic casing (a so-called “sleeve”) in order to adapt to the particular pressure image. In order to apply this plastic sleeve on the cylinder the sleeve is customarily widened when being drawn on in that bores in the roller surface are loaded from within with compressed air. The resulting air cushion has the result that the sleeve is widened in the μm range and can therefore be drawn over the pressure cylinder. The compressed air used in this connection is usually under a pressure of ca. 5-10 bar as a function of the dimensions of the cylinder and the number of bores.

After the application of the sleeve the compressed air supply to the bores in the surface of the cylinder is interrupted so that the sleeve returns into its original form adapted to the diameter of the cylinder and then rests without slipping on this form in the following due to the frictional forces between sleeve and cylinder surface.

Of course, a corresponding drawing of the sleeve onto the pressure cylinder does not take place during the non-rotating state of the cylinder.

According to the previously known systems for supplying compressed air from the inside to the bores in the cylinder surface, the cylinder has at least one axial air conduit in its interior. This conduit empties on a front side of the cylinder whereby the bores extend from the cylinder surface radially inward to the axial air conduit and have a compressed-air connection with the latter.

The axial air conduit is then customarily loaded via its opening on the front side of the cylinder with compressed air by a compressed air supply, for example, a pump.

However, such an axial compressed air supply has various disadvantages. On the one hand the width of the pressure machine is significantly enlarged on account of the compressed air supply axially following the pressure cylinder. Also, an axial compressed air supply is basically only possible if the front surface of the pressure cylinder is freely accessible. This is usually only the case if the drive of the pressure cylinder takes place in a radial manner, e.g., via gears or toothed belts.

However, if the drive of the pressure cylinder takes place, for example, via an axially mounted servomotor, then the front surface of the pressure cylinder is not available or available only to a very limited extent for the connection of a compressed air supply.

In this case radial rotary leadthroughs were previously used. However, they also have several disadvantages. Thus, on the one hand additional mounting space is required. On the other hand, correspondingly complicated and expensive parts are involved that must be purchased and necessitate high costs and can be adapted, if at all, only in a limited fashion to the particular requirements. Finally, these radial rotary leadthroughs are distinguished by a limited service life since the corresponding seals rest on the rotary cylinder during its rotation in a grinding manner and are thus subjected to great wear.

### SUMMARY OF THE INVENTION

According to one or more embodiments of the present invention, a stationary radial compressed air supply to a rotatable roller provides a supply that is distinguished by a small mounting space and by a long service life.

In the stationary radial compressed air supply in accordance with one or more embodiments of the invention to a rotatable roller the roller has at least one opening in its surface that is to be loaded with compressed air. The roller is surrounded in the axial area of the opening to be loaded with compressed air, i.e., the axial section of the roller surface in which the opening is arranged, by a stationary pressure chamber that can be loaded at least in sections with pressure in the circumferential direction. Furthermore, according to one or more embodiments of the invention, a sealing element is present that can be moved by loading the pressure chamber with compressed air from a position of rest into a sealing position and by relieving the pressure of the pressure chamber to the ambient pressure from the sealing position into the position of rest. The sealing element and the pressure chamber are constructed in such a manner that when the sealing element is in the position of rest there is no connection between the roller and the walls of the pressure chamber and thus no contact between rotating and stationary structural parts whereas when the sealing element is in the sealing position there is a pressure-tight connection between the walls of the pressure chamber and the roller.

It is consequently prevented by the sealing element, that assumes two different positions in accordance with one or more embodiments of the invention, as well as by a geometry of the sealing element and of the pressure chamber that are adapted to one another, that in the rotating state of the roller, i.e., in the pressure-free state of the pressure chamber, structural components of the pressure chamber rest in a grinding manner on the roller surface or on rotating structural parts arranged on it and are therefore exposed to great wear.

The pressure chamber surrounds, viewed in the circumferential direction here, the corresponding axial area of the roller substantially over the entire range of 360°, thus it is constructed as an annular chamber. It is ensured in this manner that the opening to be loaded with compressed air and in the roller surface comes to rest completely inside the covering range of the pressure chamber independently of the rotational position of the roller so that in any case an effective supply of compressed air is possible.

However, it would be alternatively conceivable here that the pressure chamber extends only over one or more angular sections of the circumference of the roller. In this case it would then have to be ensured by appropriate control apparatuses that a loading of the pressure chamber is only possible when the opening to be loaded is in the active area of the pressure chamber. In this sense a loading of the roller with pressure is then possible only in certain rotational positions.

The active sealing element according to one or more embodiments of the invention can be arranged here on the rotatable roller as well as in a stationary manner, for example, as a seal integrated into the pressure chamber. However, according to one or more embodiments of the invention, the sealing element is arranged in the form of at least one circumferential sealing ring on the roller surface.

The sealing element advantageously consists at least partially of an elastically deformable material such as, e.g., nitrile rubber (acrylonitrile-butadiene rubber, also known as NBR) or of another natural or synthetic rubber or type of rubber. This has the advantage that a transition between the sealing position assumed during loading with pressure and between the position of rest of the sealing element assumed in the pressure-free state is achieved by a pressure-conditioned elastic deformation.

However, it would alternatively also be conceivable that the sealing element has rigid structural parts to this end that can move mechanically between the two positions. Pivotably supported valve-like flaps or the like would also be conceivable here that are prestressed into the position of rest by a prestressing and which pivot into the sealing position upon the loading of the pressure chamber with pressure.

In the stationary compressed air supply in accordance with one or more embodiments of the invention the sealing element comprises at least one elastically deformable sealing lip. In this case the sealing lip assumes the function in accordance with one or more embodiments of the invention of a transition between the position of rest and the sealing position as a function of the pressure conditions in the pressure chamber. The sealing lip assumes its position of rest in the non-elastically deformed state and elastically deforms into the sealing position when the pressure chamber is loaded with pressure.

In order to bring it about that the sealing element automatically goes into the sealing position when the pressure chamber is loaded with compressed air, the sealing element can have an active surface arranged in such a manner that it is loaded with a force upon a pressure difference between the inner pressure of the pressure chamber and the ambient pressure which force results in an elastic deflection of the active surface and therewith to the transition into the sealing position.

In one or more embodiments of the invention, the sealing element has a contact surface with which it rests in its sealing position in a sealing manner on a wall of the pressure chamber. An areal contact is advantageous in order to ensure a sealing function which is as optimal as possible.

In order to keep the additional structural space required for mounting the compressed air supply according to one or more embodiments of the invention as small as possible the pressure chamber is arranged between roller bearings of the roller.

In this sense the pressure chamber can be integrated in an especially advantageous manner into the axial adjustment unit of the roller so that the roller can be loaded with compressed air in every axial adjustment state. In other words, the pressure chamber also performs every axial adjustment of the roller in this case so that it is always ensured that the opening to be loaded with compressed air and in the roller surface remains in the covered area of the pressure chamber.

The roller according to one or more embodiments of the invention, has several openings on its surface in the axial area surrounded by the pressure chamber that are advantageously uniformly distributed over its circumference and are to be loaded with compressed air.

In order to forward the loading with compressed air inside the roller body to the desired positions, the opening to be loaded with compressed air extends from the roller surface radially inward to an axial air conduit. This air conduits then conducts the compressed air in a customary manner to the bores arranged in another axial section of the roller by means of which bores the sleeve to be drawn on is loaded with compressed air in order to widen it.

### BRIEF DESCRIPTION OF DRAWINGS

FIG. 1 shows a sectional view of a bearing of a pressure cylinder comprising the compressed air supply in accordance with one or more embodiments of the invention;

FIG. 2 shows an enlarged detail view of the compressed air supply of FIG. 1, whereby the sealing element is shown in its position of rest;

FIG. 3 shows an enlarged detail view of the compressed air supply of FIG. 2, whereby the sealing element is shown in its sealing position, and

FIG. 4 shows a detailed view from FIG. 2 showing the arrangement of the sealing element on the compressed air cylinder.

### DETAILED DESCRIPTION

Exemplary embodiments of the invention will be described with reference to the accompanying figures. Like items in the figures are shown with the same reference numbers. In embodiments disclosed herein, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

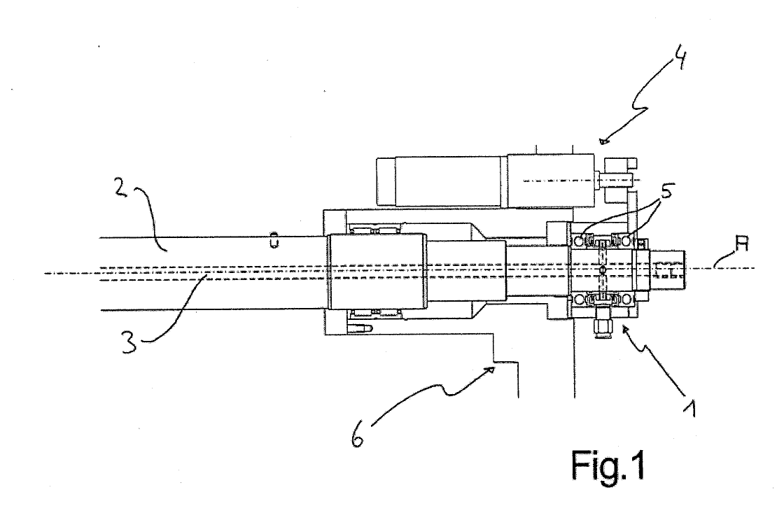

FIG. 1 shows a survey view of a bearing for a pressure cylinder 2 comprising the compressed air supply 1 in accordance with one or more embodiments of the invention. Pressure cylinder 2 is supported in the customary manner by several bearings in a machine frame 6. In particular, pressure cylinder 2 comprises an axial adjustment unit 4 that makes possible an axial shifting of cylinder 1 relative to machine frame 6.

An axially running air conduit 3 is centrally arranged inside pressure cylinder 2. This conduit 3 has a compressed-air connection with several (not shown) bores in the surface of cylinder 2. When axial air conduit 3 is loaded with compressed air, this compressed air is transmitted to the bores and can then be used to widen a plastic sleeve to be drawn onto cylinder 2 by an air cushion in order to make possible the drawing-on procedure.

The radial stationary compressed air supply in accordance with one or more embodiments of the invention is arranged in axial adjustment unit 4 between the two roller bearings 5.

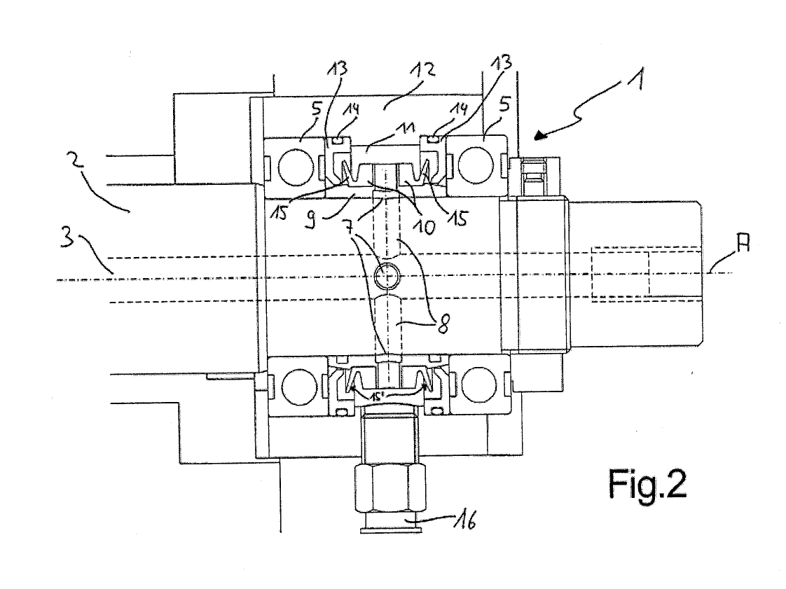

As can be recognized more precisely in FIG. 2, the surface of pressure cylinder 2 comprises four openings 7 uniformly distributed over the circumference of cylinder 2 in the axial area between the two roller bearings 5 which openings have a compressed-air connection to axial air conduit 3 via bores 8 extending radially inward.

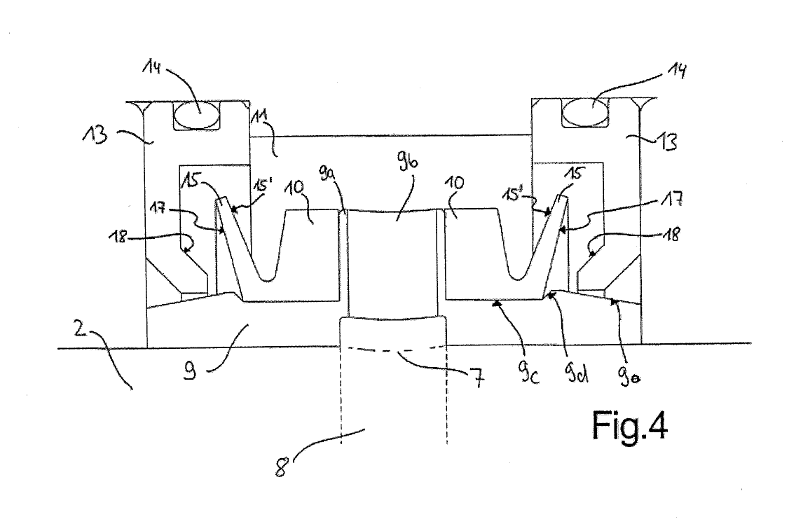

A sleeve 9 is arranged on the surface of pressure cylinder 2 in the area between roller bearings 5 which sleeve rotates without slippage with the pressure cylinder. As FIG. 4 shows, sleeve 9 has, viewed in cross section, a bead 9a in the middle area of its outside. Bead 9a has through bores 9b aligned with openings 7.

The outside of sleeve 9, viewed in cross section, extends from bead 9a at first on both sides via section 9c parallel to axis A of pressure cylinder 2 to the outside. This section is followed by a shoulder 9d running radially outward followed by a straight-line section 9e running radially slightly inward.

A sealing ring 10 of acrylonitrile butadiene rubber (NBR) is drawn onto sleeve 9 on both sides of central bead 9a in area 9c. Sealing rings 10 rotate without slippage jointly with sleeve 9 and therefore with pressure cylinder 2.

The sealing rings are secured against an axial movement on the one side by the particular wall of bead 9 and on the other side by shoulder 9d on the outside of sleeve 9.

Furthermore, the axial section of cylinder 2 located between roller bearings 5 and therefore also sealing rings 10 are surrounded by a stationary annular chamber as the pressure chamber 11 in accordance with one or more embodiments of the invention. Pressure chamber 11 is limited here radially by structural part 12 of axial adjustment unit 4, which structural part receives the roller bearings. The axially viewed lateral walls of pressure chamber 11 are formed by annular elements 13 resting on roller bearings 5 and structural part 12. In particular, O-rings are arranged here between annular elements 13 and structural part 12 in order to ensure a sealing of compressed air between these structural parts.

The sealing element in accordance with one or more embodiments of the invention is formed by two sealing lips 15 that are constructed here as an integral component of the particular sealing ring 10 and thus also consist of the elastic material acrylonitrile butadiene rubber (NBR).

In FIG. 2 and in FIG. 4 sealing lips 15 are shown in their position of rest i.e., pressure chamber 11 is not loaded with compressed air. Annular elements 13 forming the lateral walls of pressure chamber 11 are dimensioned in such a manner here that they are slightly distanced from sealing rings 10 and from sections 9e of sleeve 9 arranged on the surface of the pressure cylinder, i.e., that when sealing lips 15 are in the rest position there is no contact between annular elements 13 and sealing ring 10 and between sealing lips 15 or sleeve 9.

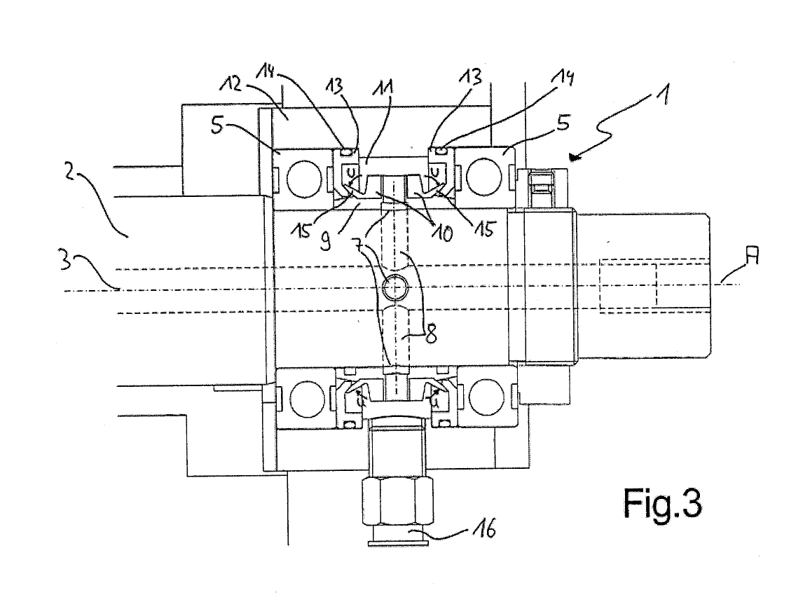

When pressure chamber 11 is loaded with compressed air via supply 16 a force acts on active surface 15′ of the particular sealing lip 15 on account of the pressure difference building up between the interior of pressure chamber 11 and the surroundings which force has the result that sealing lip 15 moves out of its position of rest shown in FIG. 2 by a pivoting movement in the direction designated in FIG. 3 by arrow U into its sealing position shown in FIG. 3.

In the sealing position sealing lip 15 rests with its outer surface 17 opposite active surface 15′ on the wall of pressure chamber 11, more precisely stated, on the obliquely running surface 18 of annular element 13 and thus seals pressure chamber 11 against the surroundings.

As a consequence of the seal of pressure chamber 11, openings 7 can be loaded with the pressure prevailing in pressure chamber 11 and the compressed air made available via bores 8 and axial air conduit 3 for widening the sleeve.

If no more compressed air is introduced via supply 16 into pressure chamber 11, the superpressure prevailing in pressure chamber 11 is reduced via axial air conduit 3 and the bores in the cylinder. Since no forces conditioned by pressure differences act any longer on active surfaces 15′ of sealing lips 15 in the pressure-free state of pressure chamber 11, these surfaces return into the position of rest shown in FIG. 2 on account of their elasticity.

According to one or more embodiments of the invention there is consequently no contact in the pressure-free state of pressure chamber 11 between sleeve 9, that can rotate with cylinder 2, and sealing ring 10 or sealing lips 15 and the stationary walls of pressure chamber 11, so that these rotating elements 9, 10, 15 are not exposed to any wear during a rotation of cylinder 2 due to a grinding contact with stationary structural parts, e.g., annular elements 13.

Due to the elasticity of sealing lips 15 and the arrangement of active surfaces 15′ it is assured that when pressure chamber 11 is loaded with pressure an automatic transition of sealing lips 15 into the sealing position takes place in which there is a sealing contact between lips 15 in the lateral wall of sealing chamber 11 formed by annular elements 13.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### LIST OF REFERENCE NUMERALS

1 compressed air supply

2 pressure cylinder

3 axial air conduit

4 axial adjustment unit

5 roller bearing

6 machine frame

7 openings

8 bores

9a bead

9b through bore in 9a

9c section outer side 9

9d shoulder in outer side 9

9e section outer side 9

10 sealing ring

11 pressure chamber

12 structural part that receives 5

13 annular elements

14 O-rings

15 sealing lips

15′ active surfaces

16 supply

17 outer surface 15

18 oblique surface of 13

U transitional direction of 15

A axis of 2

1. A roller air supply structure comprising:
a stationary compressed air supply comprising a stationary pressure chamber that can be loaded with pressure; and
a rotatable roller that comprises at least one opening in a surface thereof operable to be loaded with compressed air from the stationary compressed air supply,
wherein the roller is surrounded in the axial area of the opening to be loaded with compressed air in the circumferential direction at least in one section by the stationary pressure chamber,
wherein the compressed air supply comprises a sealing element that can be moved by loading the pressure chamber with compressed air from a position of rest into a sealing position and by relieving the pressure of the pressure chamber to ambient pressure from the sealing position into the position of rest, and
wherein the sealing element and the pressure chamber are constructed such that when the sealing element is in the position of rest there is no connection between the roller and walls of the pressure chamber, and when the sealing element is in the sealing position there is a pressure-tight connection between the walls of the pressure chamber and the roller.

2. The roller air supply structure according to claim 1, wherein the sealing element is arranged on the roller.

3. The roller air supply structure according to claim 1, wherein the sealing element comprises an elastically deformable material.

4. The roller air supply structure according to claim 1, wherein the sealing element comprises at least one elastically deformable sealing lip.

5. The roller air supply structure according to claim 1, wherein the pressure chamber is arranged between two roller bearings of the roller.

6. The roller air supply structure according to claim 1, wherein the pressure chamber is integrated into an axial adjustment unit for the roller, so that the roller can be loaded with compressed air in every axial adjustment state.

7. The roller air supply structure according to claim 1, wherein the roller comprises several openings uniformly distributed over a circumference on a surface thereof in an axial area surrounded by the pressure chamber.

8. The roller air supply structure according to claim 1, wherein the sealing element has a contact surface with which the sealing element rests in sealing position on a wall of the pressure chamber in a sealing manner.

9. The roller air supply structure according to claim 1, wherein the sealing element has an active surface on which a force acts when the pressure chamber is loaded with compressed air on account of a developing pressure difference.

10. The roller air supply structure according to claim 2, wherein the sealing element comprises an elastically deformable material.

11. The roller air supply structure according to claim 2, wherein the sealing element comprises at least one elastically deformable sealing lip.

12. The roller air supply structure according to claim 3, wherein the sealing element comprises at least one elastically deformable sealing lip.

13. The roller air supply structure according to claim 10, wherein the sealing element comprises at least one elastically deformable sealing lip.

14. The roller air supply structure according to claim 2, wherein the pressure chamber is arranged between two roller bearings of the roller.

15. The roller air supply structure according to claim 3, wherein the pressure chamber is arranged between two roller bearings of the roller.

16. The roller air supply structure according to claim 4, wherein the pressure chamber is arranged between two roller bearings of the roller.

17. The roller air supply structure according to claim 10, wherein the pressure chamber is arranged between two roller bearings of the roller.

18. The roller air supply structure according to claim 11, wherein the pressure chamber is arranged between two roller bearings of the roller.

19. The roller air supply structure according to claim 12 wherein the pressure chamber is arranged between two roller bearings of the roller.

20. The roller air supply structure according to claim 13, wherein the pressure chamber is arranged between two roller bearings of the roller.
